(19) United States
(12) Patent Application Publication
(10) Pub. No.: US 2019/0239683 A1
(43) Pub. Date: Aug. 8, 2019

(54) BAKING MACHINE

(71) Applicant: T. F. ELECTRICAL TECHNOLOGY (SHENZHEN) CO., LTD., Shenzhen, Guangdong (CN)

(72) Inventors: Liwei Chou, Shenzhen, Guangdong (CN); Chengkuan Chou, Shenzhen, Guangdong (CN); Wenhung Chou, Shenzhen, Guangdong (CN)

(21) Appl. No.: 16/333,304

(22) PCT Filed: May 17, 2017
(86) PCT No.: PCT/CN2017/084716

§ 371 Date: Mar. 14, 2019

(51) Int. Cl. A47J 37/01; A21B 1/02

(52) U.S. Cl. CPC A47J 37/015; A21B 1/02

(57) ABSTRACT

A baking machine includes a machine base (100), two heating components (200) each disposed in a platy manner, an auxiliary fixing post (400) fixed on the machine base (100), and two groups of anti-tilt assemblies (500) fixed to the auxiliary fixing post (400) and respectively corresponding to the heating components (200); each of the anti-tilt assemblies (500) includes a first limiting member (510) fixed to the auxiliary fixing post (400) and located at one platy side of each of the heating components (200) and a second limiting member (520) that is fixed to the auxiliary fixing post (400), is located at the other platy side of each of the heating components (200), and is opposite to a position of the first limiting member (510); and intervals between the first limiting members (510) and the second limiting members (520) are matched with thicknesses of the heating components (200).

### TECHNICAL FIELD

The present application relates to the technical field of food processing, and more particularly to a baking machine.

### BACKGROUND

A baking machine includes a machine base, two heating components each disposed in a platy manner and two connecting insertion strips; one of the connecting insertion strips is connected to a platy edge of a lower side of one heating component; the connecting insertion strips are inserted into the machine base; and the two heating components are arranged vertically and are arranged in parallel, and a gap for placing a food material is reserved therebetween. Since the heating components are inserted into the machine base through the connecting insertion strips, when the heating components are subjected to a lateral external force, a large acting force is generated at the contact positions between the connecting insertion strips and a base according to a lever principle, and the connecting insertion strips and the base are deformed, resulting in that the heating components are tilted easily and laterally.

### SUMMARY

An objective of the present application is to overcome the above-mentioned shortages of the prior art and to provide a baking machine to solve the problem that heating components are tilted easily and laterally.

The present application is implemented as follows:

A baking machine for baking a food material includes a machine base, two heating components each disposed in a platy manner, and a control assembly for controlling the two heating components to heat; the two heating components are arranged vertically and are arranged in parallel, and a gap for placing the food material is reserved therebetween; the control assembly includes two electrical connectors and a controller for controlling the heating components to heat; the heating components are respectively and electrically connected to the controller via the two electrical connectors; the baking machine includes an auxiliary fixing post fixed on the machine base and two groups of anti-tilt assemblies fixed to the auxiliary fixing post and respectively corresponding to the heating components, wherein each of the anti-tilt assemblies includes a first limiting member fixed to the auxiliary fixing post and located at one platy side of each of the heating components and a second limiting member that is fixed to the auxiliary fixing post, is located at the other platy side of each of the heating components, and is opposite to a position of the first limiting member; intervals between the first limiting members and the second limiting members are matched with thicknesses of the heating components at opposite positions, and the controller is disposed in the machine base or the auxiliary fixing post.

Optionally, the first limiting members and the second limiting members all are disposed in a platy manner, and each of the first limiting members and the second limiting members is disposed opposite to each of the heating components via a platy surface.

Optionally, each of the anti-tilt assemblies includes a soft rubber block elastically propped against the heating components; and the soft rubber blocks are mounted at sides, facing the heating components, of the second limiting members.

Optionally, a soft rubber mounting groove is respectively formed at the sides, facing the heating components, of the second limiting members; the groove width of each of the mounting grooves is tapered along a notch direction; and each of the soft rubber blocks includes a mounting portion mounted in each of the soft rubber mounting grooves and a propping portion that is integrally connected with the mounting portion and is configured to prop against each of the heating components.

Optionally, the mounting grooves extend to sides, away from the auxiliary fixing post, of the second limiting members.

Optionally, the cross section of each of the mounting grooves is of a T shape, and the shapes of the cross sections of the mounting portions are matched with the groove shapes of the mounting grooves.

Optionally, the baking machine includes two groups of slip connection assemblies that are respectively configured to slidably connect the heating components to the machine base and are capable of allowing the heating components to slide to the anti-tilt assemblies.

Optionally, the slip connection assemblies each include a sliding rail connected to the machine base and a sliding block matched with the sliding rail through slip connection; and one sliding block is connected to a platy edge, facing the machine base, of one heating component.

Optionally, the cross section of each of the sliding rails is disposed in a T shape; a sliding groove matched with each of the sliding rails is formed on each of the sliding blocks; and the shapes of the cross sections of the sliding grooves are matched with the shapes of the cross sections of the sliding rails.

Optionally, the slip connection assemblies each include a rolling wheel disposed on each sliding rail; the rolling wheels are at least provided; a central axis of each of the rolling wheels is perpendicular to an extending direction of each of the sliding rails, and a wheel surface of each of the rolling wheels is propped against a groove bottom of each of the sliding grooves.

Optionally, each of the electrical connectors includes a socket disposed at the platy edge, facing the auxiliary fixing post, of each of the heating components, and a plug arranged on the auxiliary fixing post and configured to be electrically connected with the socket;

or alternatively, each of the electrical connectors includes a plug disposed at the platy edge, facing the auxiliary fixing post, of each of the heating components, and a socket arranged on the auxiliary fixing post and configured to be electrically connected with the plug.

Optionally, each of the heating components includes two semiconductor heating plates arranged in parallel and spaced apart and a structural reinforcing frame surrounding the two semiconductor heating plates.

Optionally, the semiconductor heating plates are semiconductor heating plates made of a transparent material.

Optionally, a bump protruded out of a platy surface of each of the semiconductor heating plates is respectively provided at two sides of each of the structural reinforcing frames.

Optionally, the baking machine includes lock catch assemblies for restricting the heating components from being away from the anti-tilt assemblies; each of the lock catch assemblies includes a clamping hook for matching with side buckles away from the auxiliary fixing post in the bumps and a driving mechanism for driving the clamping hooks to remove the matching between the clamping hooks and the buckles of the bumps.

Based on the structure of the present application, the auxiliary fixing post and the anti-tilt assemblies are arranged and each anti-tilt assembly includes the first limiting member located at one platy side of the each of the heating components and the second limiting member located at the other platy side of each of the heating components and disposed opposite to the position of the first limiting member. When the heating components are subjected to a lateral external force, due to the presence of the first limiting members and the second limiting members, the first limiting members restrain the heating components from tilting toward certain sides, and the second limiting members restrain the heating components from tilting toward the other sides. Therefore, the first limiting members and the second limiting members jointly restrain the heating components from tilting laterally, and thus the heating components are effectively prevented from tilting laterally.

### BRIEF DESCRIPTION OF DRAWINGS

In order to explain technical solutions of the present application more clearly, the accompanying drawings used in the embodiments will be briefly introduced below. Apparently, the accompanying drawings in the following description show merely some embodiments of the present application, and a person of ordinary skill in the art may still derive other accompanying drawings from these accompanying drawings without creative efforts.

FIG. 1 is a schematic view showing an overall structure of a baking machine provided by an embodiment of the present application, where heating components are mounted on a machine base;

FIG. 2 is a schematic view showing an overall structure of a baking machine provided by an embodiment of the present application, where heating components are not mounted on a machine base;

FIG. 3 is a schematic view of an enlarged structure of A in FIG. 2;

FIG. 4 is a schematic view of a circuit of a baking machine provided by an embodiment of the present application;

FIG. 5 is a structural schematic view of a slip connection assembly of a baking machine provided by an embodiment of the present application;

FIG. 6 is an exploded view of FIG. 5;

FIG. 7 is a structural schematic view of a heating component of a baking machine provided by an embodiment of the present application;

FIG. 8 is a cross-sectional view showing a heating component and a clamping hook of a baking machine provided by an embodiment of the present application; and

FIG. 9 is a structural schematic view of a lock catch assembly of a baking machine provided by an embodiment of the present application.

### NUMERALS IN THE DRAWINGS

| Numerals | Name | Numerals | Name |
|---|---|---|---|
| 100 | Machine base | | |
| 200 | Heating component | | |
| 210 | Semiconductor heating plate | 220 | Structural |
| | | | reinforcing frame |
| 300 | Control assembly | | |
| 310 | Electrical connector | | |
| 311 | Socket | 312 | Plug |
| 320 | Controller | | |
| 400 | Auxiliary fixing post | | |
| 500 | Anti-tilt assembly | | |
| 510 | First limiting member | | |
| 520 | Second limiting member | | |
| 530 | Soft rubber block | | |
| 540 | Third limiting member | | |
| 600 | Slip connection assembly | | |
| 610 | Sliding rail | | |
| 620 | Sliding block | 621 | Sliding groove |
| 630 | Rolling wheel | | |
| 700 | Lock catch assembly | | |
| 710 | Clamping hook | | |
| 720 | Driving mechanism | | |
| 721 | Wedge block | 722 | Press key |
| 800 | Heat insulation plate | | |
| 900 | Lifting-lowering assembly | | |

### DESCRIPTION OF EMBODIMENTS

To make the objectives, technical solutions, and advantages of the present application clearer and more comprehensible, the following further describes the present application in detail with reference to the accompanying drawings and embodiments. It should be understood that the specific embodiments described herein are merely used to explain the present application and are not intended to limit the present application.

An embodiment of the present application provides a baking machine for baking a food material, where the food material may be a flaky food material such as a piece of toasted bread, or may be a non-flaky food material.

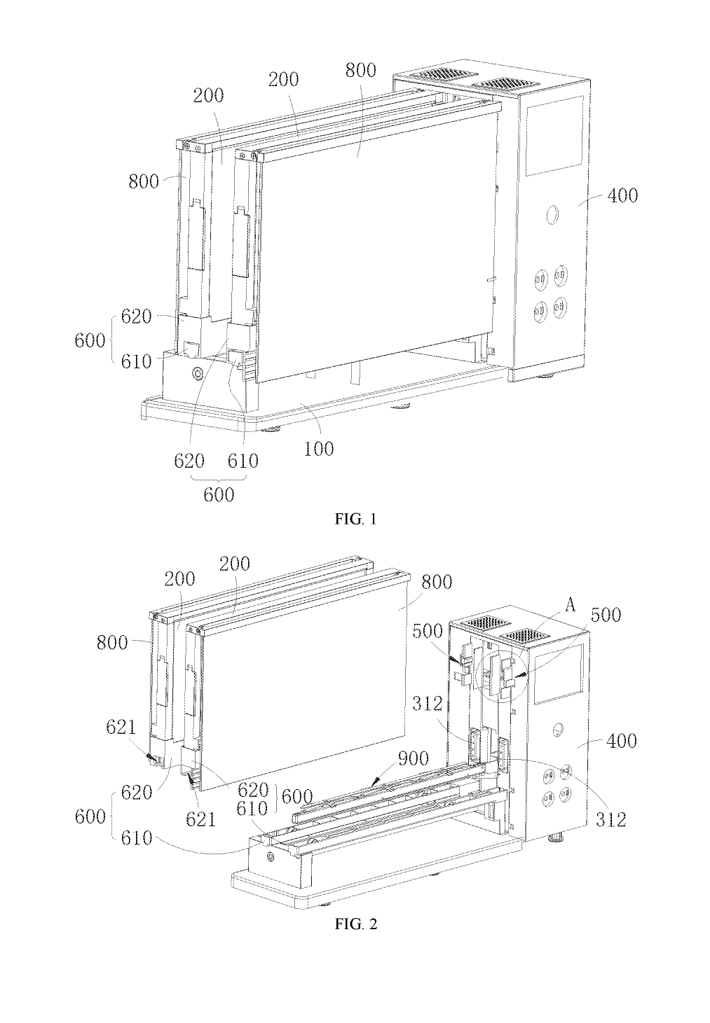

Referring to FIG. 1 to FIG. 4, the baking machine includes a machine base 100, two heating components 200 each disposed in a platy manner, and a control assembly 300 for controlling the two heating components 200 to heat. The two heating components 200 are arranged vertically and are arranged in parallel, and a gap for placing the food material is reserved therebetween, where an interval between the two heating components 200 is designed according to a use requirement. The control assembly 300 includes two electrical connectors 310 and a controller 320 for controlling the heating component 200 to heat. The heating components 200 are respectively and electrically connected to the controller 320 via the two electrical connectors 310, where the controller 320 can be used for controlling heating temperatures, heating time and the like of the two heating components 200.

In this embodiment of the present application, the baking machine includes an auxiliary fixing post 400 fixed to the machine base 100 and two groups of anti-tilt assemblies 500 respectively fixed to the auxiliary fixing post 400 and corresponding to the heating components 200, where each of the anti-tilt assemblies 500 includes a first limiting member 510 fixed to the auxiliary fixing post 400 and located at one platy side of each of the heating components 200 and a second limiting member 520 that is fixed to the auxiliary fixing post 400, is located at the other platy side of each of the heating components 200, and is opposite to the position of the first limiting member 510; intervals between the first limiting members 510 and the second limiting members 520 are matched with thicknesses of the heating components 200 at the opposite positions, and the first limiting members 510 and the second limiting members 520 jointly prop against the heating components 200. In this embodiment of the present application, the controller 320 is disposed in the auxiliary fixing post 400. In other embodiments, the controller 320 may also be disposed in the machine base 100.

In the embodiment of the present application, the auxiliary fixing post 400 and the anti-tilt assemblies 500 are arranged and each anti-tilt assembly 500 includes the first limiting member 510 located at one platy side of each of the heating components 200 and the second limiting member 520 located at the other platy side of each of the heating components 200 and disposed opposite to the position of the second limiting member 520. When the heating components are subjected to a lateral external force, due to the presence of the first limiting members 510 and the second limiting members 520, the first limiting members 510 restrain the heating components 200 from tilting toward certain sides, and the second limiting members 520 restrain the heating components 200 from tilting toward the other sides; and the first limiting members 510 and the second limiting members 520 jointly restrain the heating components from tilting laterally, and thus the heating components are effectively prevented from tilting laterally.

Referring to FIG. 1, FIG. 2 and FIG. 7, in this embodiment of the present application, the first limiting members 510 and the second limiting members 520 all are disposed in a platy manner, and each of the first limiting members 510 and the second limiting members 520 is disposed opposite to each of the heating components 200 via a platy surface. In order to prevent the heating components 200 from tilting laterally, each of the first limiting members 510 and the second limiting members 520 is provided with a propping surface propped against each of the heating components 200, where the larger the propping surfaces, the better the lateral tilting prevention effect of the first limiting members 510 and the second limiting members 520. Based on such a structure, while it is ensured that the first limiting members 510 and the second limiting members 520 have the large propping surfaces, the material use of the first limiting members 510 and the second limiting members 520 can be reduced and thus the cost is reduced.

Further, each of the anti-tilt assemblies 500 includes a soft rubber block 530 elastically propped against the heating components 200; and the soft rubber blocks 530 are mounted at sides, facing the heating components 200, of the second limiting members 520. Since the heating components 200 are to heat food, in order to ensure the cleanliness and the hygiene, it is generally detachable between the heating components 200 and the machine base 100. Based on this structure, with the arrangement of the soft rubber blocks 530, the matching resistance between the heating components 200 and the anti-tilt assemblies 500 is increased. Particularly, during the use and during the process when the heating components 200 are mounted on the anti-tilt assemblies 500, a certain external force is required to mount the heating components 200 on the anti-tilt assemblies 500; and in this way, whether the mounting is in place or not is perceived conveniently. In addition, since the soft rubber blocks 530 are elastic, no damage will be caused to the heating components 200. Specifically, in this embodiment of the present application, the soft rubber blocks are made of a rubber.

Further, a soft rubber mounting groove is respectively formed at the sides, facing the heating components 200, of the second limiting members 520; the groove width of each of the mounting grooves is tapered along a notch direction; and each of the soft rubber blocks 530 includes a mounting portion mounted in each of the soft rubber mounting grooves and a propping portion that is integrally connected with the mounting portion and is configured to prop against each of the heating components 200. Based on this structure, when the soft rubber blocks 530 are mounted on the second limiting members 520, only the mounting portions need to be pressed into the soft rubber mounting grooves, and the soft rubber blocks 530 and the second limiting members 520 do not need to be bonded. When the soft rubber blocks 530 are dismantled from the second limiting members 520, only an external force for making the soft rubber blocks 530 away from the soft rubber mounting grooves is applied to the soft rubber blocks 530 to force the mounting portions to deform to some extent; and thus, the mounting and the dismantling of the soft rubber blocks 530 are very simple and convenient without the need for a tool.

Still further, the mounting grooves extend to sides, away from the auxiliary fixing post, of the second limiting members 520. Based on this structure, when the soft rubber blocks 530 are mounted on the second limiting members 520, only the mounting portions need to be slid into the soft rubber mounting grooves. When the soft rubber blocks 530 are dismantled from the second limiting members 520, only an external force is applied to the soft rubber blocks 530 so that the soft rubber blocks 530 are slid away from the soft rubber mounting grooves, and thus the efficiency of mounting and dismantling the soft rubber blocks 530 is further improved.

Still further, the cross section of each of the mounting grooves is of a T shape, and the shapes of the cross sections of the mounting portions are matched with the groove shapes of the mounting grooves.

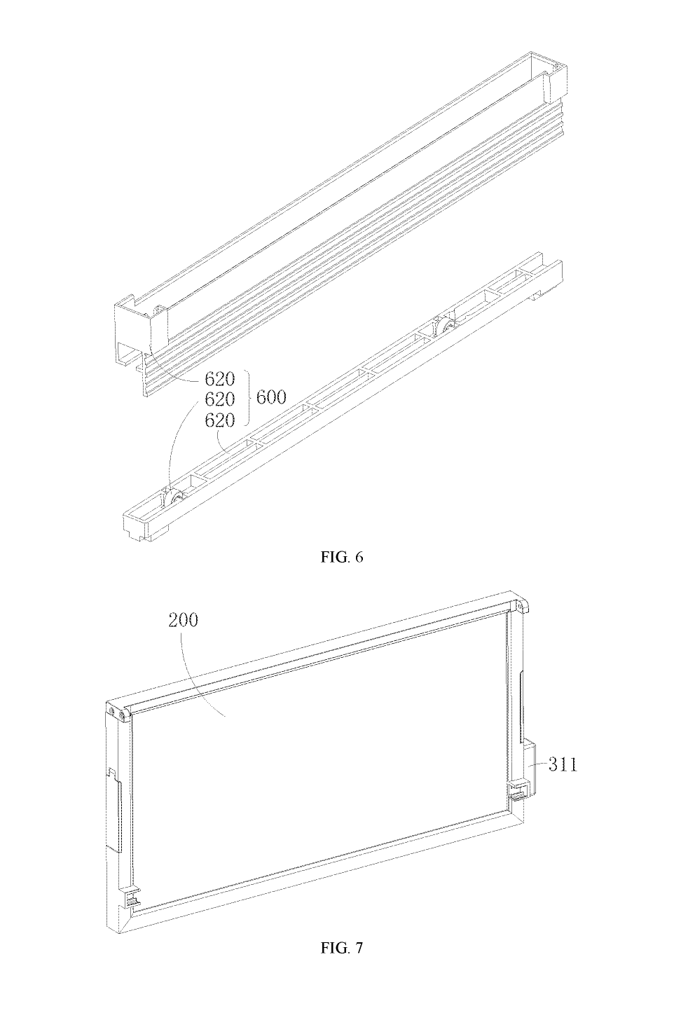

Referring to FIG. 1, FIG. 2, FIG. 5 and FIG. 6, in this embodiment of the present application, the baking machine includes two groups of slip connection assemblies 600 that are respectively configured to slidably connect the heating components 200 to the machine base 100 and are capable of allowing the heating components 200 to slide to the anti-tilt assemblies 500; the slip connection assemblies 600 each include a sliding rail 610 connected to the machine base 100 and a sliding block 620 matched with the sliding rail 610 through slip connection; and one sliding block 620 is connected with a platy edge, facing the machine base 100, of one heating component 200. Since the matching relationship between the sliding rails 610 and the sliding blocks 620 has the characteristic that only one part needs to be matched and then the follow-up matching for the rest can be completed by enabling the sliding blocks 620 to slide along the sliding rails 610; and only by complete matching between the sliding blocks 620 and the sliding rails 610 in the length direction can the assembly be performed. Therefore, based on this structure, the arrangement of the slip connection assemblies 600 is also favorable for improving the assembly efficiency between the heating components 200 and the machine base 100.

Further, the cross section of each of the sliding rails 610 is disposed in a T shape; a sliding groove 621 matched with each of the sliding rails 610 is formed on each of the sliding blocks 620; and the shapes of the cross sections of the sliding grooves 621 are matched with the shapes of the cross sections of the sliding rails 610. Thus, based on the structural design of the sliding rails 610 and the sliding grooves 621, the sliding rails 610 and the sliding blocks 620 can be effectively prevented from departing along opening directions of the sliding grooves 621.

Further, the slip connection assemblies 600 each include a rolling wheel 630 disposed on each sliding rail 610; the rolling wheels 630 are at least provided; a central axis of each of the rolling wheels 630 is perpendicular to an extending direction of each of the sliding rails 610, and a wheel surface of each of the rolling wheels 630 is propped against a groove bottom of each of the sliding grooves 621. Based on this structure, with the arrangement of the rolling wheels 630, a frictional force between the sliding rails 610 and the sliding blocks 620 is converted into a rolling friction. In this way, it is beneficial to reducing a friction coefficient and thus a frictional force during the sliding is reduced.

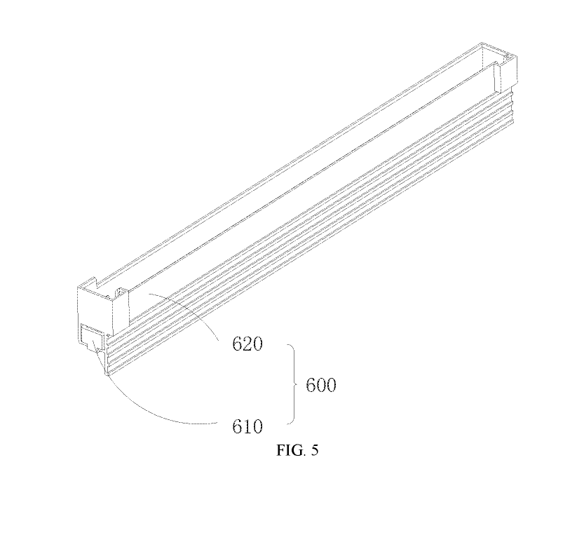

Referring to FIG. 2, FIG. 4 and FIG. 7, in this embodiment of the present application, each of the electrical connectors 310 includes a socket 311 disposed at the platy edge, facing the auxiliary fixing post 400, of each of the heating components 200 and a plug 312 arranged on the auxiliary fixing post 400 and configured to be electrically connected with the socket 311. Thus, during the process when the heating components 200 are mounted on the machine base 100, the heating components 200 are electrically connected with the controller 320. In other embodiments, each of the electrical connectors 310 includes a plug 312 disposed at the platy edge, facing the auxiliary fixing post 400, of each of the heating components 200 and a socket 311 arranged on the auxiliary fixing post 400 and configured to be electrically connected with the plug 312.

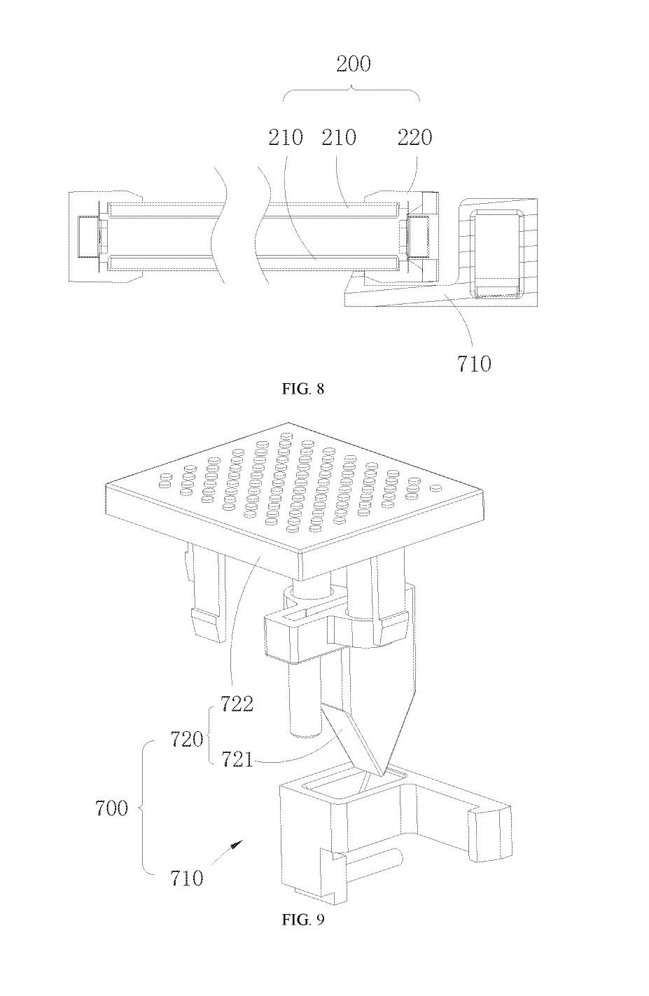

Referring to FIG. 8, in this embodiment of the present application, each of the heating components 200 includes two semiconductor heating plates 210 arranged in parallel and spaced apart and a structural reinforcing frame 220 surrounding the two semiconductor heating plates 210. The semiconductor heating plates 210 have the advantages of high heat efficiency and fast heating rate, and can be well applied to food baking, and thanks to the arrangement of the structural reinforcing frames 220, the semiconductor heating plates 210 are protected.

Further, the semiconductor heating plates 210 are made of a transparent material, so that a user can directly observe a baking state of the food through the semiconductor heating plates 210.

Further, a bump protruded out of a platy surface of each of the semiconductor heating plates 210 is respectively provided at two sides of each of the structural reinforcing frames 220. Therefore, when the heating components 200 are placed flat on a plane of a supporting surface, such as a table top, with the arrangement of the structural reinforcing frame 220, the plane of the supporting surface of the table top can be prevented from being in direct contact with the semiconductor heating plates 210.

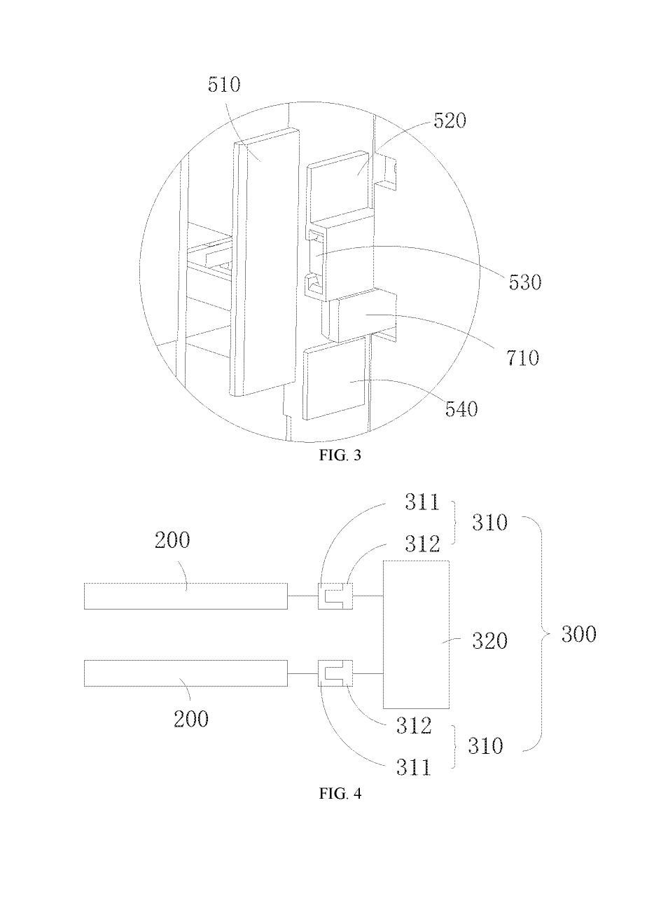

Referring to FIG. 3, FIG. 8, and FIG. 9, the baking machine includes lock catch assemblies 700 for restraining the heating components 200 from being away from the anti-tilt assemblies 500; each of the lock catch assemblies 700 includes a clamping hook 710 for matching with side buckles away from the auxiliary fixing post 400 in the bumps and a driving mechanism 720 for driving the clamping hooks 710 to remove the matching between the clamping hooks 710 and the buckles of the bumps. Based on this structure, with the arrangement of the lock catch assemblies 700, when the driving mechanisms 720 do not remove the matching between the clamping hooks 710 and the buckles of the bumps, the heating components 200 can be prevented from being pulled mistakenly.

Specifically, in this embodiment of the present application, each driving mechanism 720 includes a wedge block 721 matched with each of the clamping hooks 710 and a press key 722 that drives the wedge block 721 to move. Wedge surfaces of the wedge blocks 721 are propped against the clamping hooks 710. When the press keys 722 are pressed, the wedge blocks 721 are driven to move, and thus the clamping hooks 710 move to remove the matching between the clamping hooks 710 and the buckles of the bumps. In addition, the auxiliary fixing post 400 is of a cavity structure, and the lock catch assemblies 700 are disposed on the auxiliary fixing post 400. The clamping hooks 710 pass through the auxiliary fixing post 400. Punched holes for passing through the press keys 722 are formed on a top of the auxiliary fixing post 400, so that the press keys 722 are pressed by the user conveniently.

Referring to FIG. 3, based on all of the above, in this embodiment of the present application, each of the anti-tilt assemblies 500 includes a third limiting member 540 fixed to the auxiliary fixing post 400; the third limiting members 540 are located at sides, away from the first limiting members 510, of the heating components 200, and are disposed corresponding to the positions of the first limiting members 510; and the clamping hooks 710 are located between the second limiting members 520 and the third limiting members 540. Based on this structure, the anti-tilt performance of the anti-tilt assemblies 500 is further enhanced by the arrangement of the third limiting members 540.

Referring to FIG. 2, the baking machine includes a lifting-lowering assembly 900 for placing the food material and lifting and lowering the food material. The lifting-lowering assembly 900 includes a supporting frame disposed between the two heating components 200 and a lifting-lowering driver connected with a supporting rod and configured to drive the supporting rod to ascend and descend. In this way, for different foods, the positions of the foods may be appropriately adjusted.

Referring to FIG. 1 and FIG. 2, the baking machine further includes two heat insulation plates 800, and two heat insulation assemblies are respectively connected to the outsides of the heating components 200. Thus, with the arrangement of the heat insulation plates 800, the heating components 200 in a heating state can be prevented from being touched mistakenly during use, and the burns in use are prevented.

Further, the heat insulation plates 800 are made of the transparent material, so that the user observes an internal state through the heat insulation plates 800.

The above are only the preferred embodiments of the present application, and are not intended to limit the present application. Any modifications, equivalent substitutions or improvements made within the spirit and principles of the present application shall fall into the protection scope of the present application.

1. A baking machine for baking a food material, comprising a machine base, two heating components each disposed in a platy manner, and a control assembly for controlling the two heating components to heat, the two heating components being arranged vertically and being arranged in parallel, and a gap for placing the food material being reserved therebetween, the control assembly comprising two electrical connectors and a controller for controlling the heating components to heat, and the heating components being respectively and electrically connected to the controller via the two electrical connectors, wherein the baking machine comprises an auxiliary fixing post fixed on the machine base and two groups of anti-tilt assemblies fixed to the auxiliary fixing post and respectively corresponding to the heating components, wherein each of the anti-tilt assemblies comprises a first limiting member fixed to the auxiliary fixing post and located at one platy side of each of the heating components and a second limiting member that is fixed to the auxiliary fixing post, is located at the other platy side of each of the heating components, and is opposite to a position of the first limiting member; intervals between the first limiting members and the second limiting members are matched with thicknesses of the heating components at opposite positions, and the controller is disposed in the machine base or the auxiliary fixing post.

2. The baking machine of claim 1, wherein the first limiting members and the second limiting members all are disposed in a platy manner, and each of the first limiting members and the second limiting members is disposed opposite to each of the heating components via a platy surface.

3. The baking machine of claim 1, wherein each of the anti-tilt assemblies comprises a soft rubber block elastically propped against the heating components; and the soft rubber blocks are mounted at sides, facing the heating components, of the second limiting members.

4. The baking machine of claim 3, wherein a soft rubber mounting groove is respectively formed at the sides, facing the heating components, of the second limiting members; the groove width of each of the mounting grooves is tapered along a notch direction; and each of the soft rubber blocks comprises a mounting portion mounted in each of the soft rubber mounting grooves and a propping portion that is integrally connected with the mounting portion and is configured to prop against each of the heating components.

5. The baking machine of claim 4, wherein the mounting grooves extend to sides, away from the auxiliary fixing post, of the second limiting members.

6. The baking machine of claim 5, wherein the cross section of each of the mounting grooves is of a T shape, and the shapes of the cross sections of the mounting portions are matched with the groove shapes of the mounting grooves.

7. The baking machine of claim 1, wherein the baking machine comprises two groups of slip connection assemblies that are respectively configured to slidably connect the heating components to the machine base and are capable of allowing the heating components to slide to the anti-tilt assemblies.

8. The baking machine of claim 7, wherein the slip connection assemblies each comprise a sliding rail connected to the machine base and a sliding block matched with the sliding rail through slip connection; and one sliding block is connected to a platy edge, facing the machine base, of one heating component.

9. The baking machine of claim 8, wherein the cross section of each of the sliding rails is disposed in a T shape; a sliding groove matched with each of the sliding rails is formed on each of the sliding blocks; and the shapes of the cross sections of the sliding grooves are matched with the shapes of the cross sections of the sliding rails.

10. The baking machine of claim 9, wherein the slip connection assemblies each comprise a rolling wheel disposed on each sliding rail a central axis of each of the rolling wheels is perpendicular to an extending direction of each of the sliding rails, and a wheel surface of each of the rolling wheels is propped against a groove bottom of each of the sliding grooves.

11. The baking machine of claim 1, wherein each of the electrical connectors comprises a socket disposed at the platy edge, facing the auxiliary fixing post, of each of the heating components, and a plug arranged on the auxiliary fixing post and configured to be electrically connected with the socket;
or alternatively, each of the electrical connectors comprises a plug disposed at the platy edge, facing the auxiliary fixing post, of each of the heating components, and a socket arranged on the auxiliary fixing post and configured to be electrically connected with the plug.

12. The baking machine of claim 1, wherein each of the heating components comprises two semiconductor heating plates arranged in parallel and spaced apart and a structural reinforcing frame surrounding the two semiconductor heating plates.

13. The baking machine of claim 12, wherein the semiconductor heating plates are semiconductor heating plates made of a transparent material.

14. The baking machine of claim 12, wherein a bump protruded out of a platy surface of each of the semiconductor heating plates is respectively provided at two sides of each of the structural reinforcing frames.

15. The baking machine of claim 14, wherein the baking machine comprises lock catch assemblies for restricting the heating components from being away from the anti-tilt assemblies; each of the lock catch assemblies comprises a clamping hook for matching with side buckles away from the auxiliary fixing post in the bumps and a driving mechanism for driving the clamping hooks to remove the matching between the clamping hooks and the buckles of the bumps.
